(19) United States
(12) Patent Application Publication
(10) Pub. No.: US 2024/0317560 A1
(43) Pub. Date: Sep. 26, 2024

(54) Securing Assembly, Base, and Lifting Aid

(71) Applicant: 123Lash Pte Limited, Singapore (SG)

(72) Inventor: David Robin Bean, Windsor, New South Wales (AU)

(21) Appl. No.: 18/575,435

(22) PCT Filed: Jun. 28, 2022
(86) PCT No.: PCT/SG2022/050447

§ 371 Date: Dec. 29, 2023

(30) Foreign Application Priority Data
Jun. 30, 2021 (AU) 2021901984

(51) Int. Cl. B66F 11/00

(52) U.S. Cl. CPC B66F 11/00; B66F 2700/09

(57) ABSTRACT

A base for a securing assembly having a lower end that secures objects to a structure, the base including, a base frame having a joining wall and at least two sidewalls extending from the joining wall to an opening for receiving the lower end in a cavity: a base pin extending between the sidewalls for attaching the base to the structure: an arm movable between an open position, wherein the arm is positioned such that the lower end is movable through the opening, and a securing position, wherein the arm inhibits movement of the lower end from the cavity.

### FIELD

The present invention relates to a securing assembly for securing objects to a structure, a base therefor, and a lifting aid therefor.

### BACKGROUND

In most container ports more than 30% of injuries are related to the task of lashing, which is the attachment of securing assemblies, commonly referred to as lashes, to objects, such as containers, to structures, such as ships. Lashing workers are performing heavy, awkward work, frequently on an exposed, often slippery, deck. The environment is constantly changing, difficult to supervise and dangerous. Most lashes in current use require two operators to install and/or remove entirely manually. This adds to cost and while reducing the chance of strain through overloading adds to risk from one worker striking another by accident on a space constrained deck.

Lashes are inherently quite heavy. A lash assembly typically weighs upwards of 21 kg. Their weight combined with length and shape makes them awkward to handle. To make the task more manageable the components are currently designed to be disconnected so that smaller sub-assemblies can be handled one at a time. This results in a process where most of the physical effort and time is related to handling of these parts, which does not add value to the process of securing the object to the structure. Additionally, the effort to assemble or disassemble, and to tighten or loosen a lash is significant. The pool of workers who are strong enough to work with existing lashes is quite small and almost entirely male.

Lashes are typically adjustable because containers have different heights, or deck layouts differ from ship to ship. The lashes thus need to be adjusted to suit each combination of containers.

Delay between the time a ship arrives and the time of the first “box” being unloaded is an issue for ship operators. This delay is often caused in large part by the time taken to unlash enough boxes before a crane used to move containers can safely start work in an area where there are no people. The resulting time pressure to remove lashes results in hurried work and, in some instances, injury and even death. Even the fastest lashing teams struggle to go faster than the crane. As a result the crane must be either held back or deployed elsewhere to keep workers safe.

Many presently used lashes use a bottle screw to create tension between a top rod and a bottom rod. The bottle screw is commonly stored standing up against a handrail of the ship. The top rod is then carried elsewhere to be stored, or it is just dropped onto the deck of the ship, where it becomes a trip hazard. The handling time of these components is almost as long as the time to attach the lash in many cases.

The deck area of a ship is often space constrained. This is made worse by the need for the lashing bars to be attached in a way that allows a turnbuckle that operates the bottle screw to be rotated. This extra clearance requires the bars to stand out at an angle from the container face. The deck on many ships becomes more cluttered by lashing encroaching on walkways. After removal, the lashes are generally stored on deck. In some ships this is done neatly in dedicated bins and racks, in others it results in bars being stored on walkways, resulting in slip and trip hazards.

### SUMMARY OF INVENTION

It is an object of the present invention to address or overcome one or more of the above disadvantages, or at least provide a useful alternative to the above-mentioned securing assemblies.

In a first embodiment, the present invention seeks to provide a base for a securing assembly having a lower end that secures objects to a structure, the base including a base frame having a joining wall and at least two sidewalls extending from the joining wall to an opening for receiving the lower end in a cavity, a base pin extending between the sidewalls for attaching the base to the structure, an arm movable between an open position, wherein the arm is positioned such that the lower end is movable through the opening, and a securing position, wherein the arm inhibits movement of the lower end from the cavity.

In a further embodiment, the present invention seeks to provide a securing assembly for securing an object to a structure, the assembly including a frame extending along a frame axis, a first arm movably connected to the frame, the first arm having a lower end adapted to connect to the structure, and an upper end connected to the frame, a second arm having a lower end connected to the frame, and an upper end extending away from the frame, and an engaging member attached to the upper end of the second arm, the engaging member being adapted to engage an attachment point of the object, wherein the first arm is movable between a securing position, wherein the lower end is connectable to the structure, and a stowed position, wherein the first arm is at least partly received by the frame such that at least a portion of a projection of the first arm along the frame axis overlaps a portion of a projection of the second arm along the frame axis.

### BRIEF DESCRIPTION OF DRAWINGS

Preferred embodiments of the present invention will now be described, by way of examples only, with reference to the accompanying drawings:

FIG. 1 shows a perspective view of a base for the securing assembly, base and lifting aid of an embodiment of the present invention;

FIG. 2 shows a side view of the base of FIG. 1;

FIG. 3 shows a side view of the base of FIG. 1;

FIG. 4 side view of the base of FIG. 1;

FIG. 5 shows a perspective view of the base of FIG. 1;

FIG. 6 shows a perspective view of a securing assembly according to an embodiment of the present invention;

FIG. 7 shows a perspective view of a frame for the securing assembly of FIG. 6;

FIG. 8 shows a perspective view of a top bracket for use with the securing assembly of FIG. 6;

FIG. 9 shows an exploded view of the top bracket of FIG. 8;

FIG. 10 shows a perspective view of a nut assembly for the securing assembly of FIG. 6;

FIG. 11 shows a perspective view of a slider of the nut assembly of FIG. 10;

FIG. 12 shows a perspective view of the slider of FIG. 11;

FIG. 13 shows a perspective view of a stow bracket of the securing assembly of FIG. 6;

FIG. 14 shows a bottom bracket of the Frame of FIG. 7;

FIG. 15 is a partial perspective view of a top arm used with the securing assembly of FIG. 6;

FIG. 16 shows a partial exploded perspective view of the top arm of FIG. 15;

FIG. 17 is a partial perspective view of the top arm of FIG. 15;

FIG. 18 is a perspective view of the top arm of FIG. 15;

FIG. 19 is a partial perspective view of the securing assembly of FIG. 6 in a stowed arrangement;

FIG. 20 is a perspective view of an arm used with the securing assembly of FIG. 6;

FIG. 21 is a side view of the securing assembly in the stowed position of FIG. 19;

FIG. 22 is a partial perspective view of the securing assembly of FIG. 6.

### DESCRIPTION OF EMBODIMENTS

Where reference is made in any one or more of the accompanying drawings to steps and/or features, which have the same reference numerals, those steps and/or features have for the purposes of this description the same function(s) or operation(s), unless the contrary intention appears.

It is to be noted that the discussions contained in the “Background” section and that above relating to prior art arrangements relate to discussions of documents or devices which form public knowledge through their respective publication and/or use. Such should not be interpreted as a representation by the present inventor(s) or the patent applicant that such documents or devices in any way form part of the common general knowledge in the art.

Broadly, the present invention relates to a securing assembly 200 that is used to lash shipping containers to a ship or other transportation vehicle.

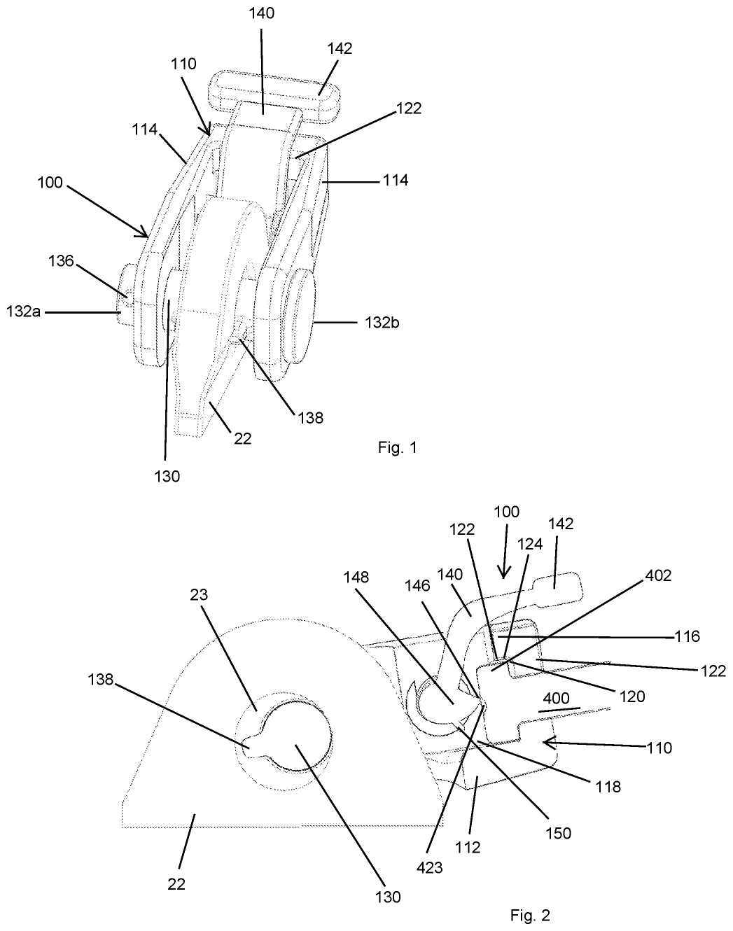

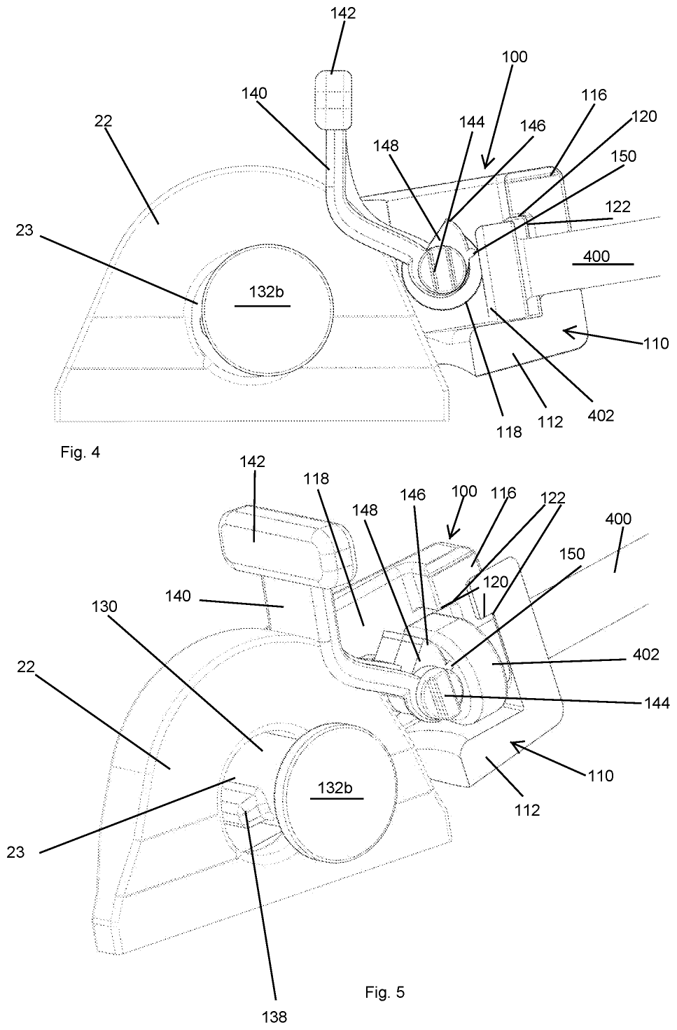

As seen in FIGS. 1 to 5, a base 100 of the securing assembly 200 according to a preferred embodiment of the invention is illustrated for attaching to a lower deck eye 22 attached to a structure (not shown) to which the base is to be attached to for connecting the securing assembly frame 300 of the present invention.

The base 100 includes a frame 110 with a base joining wall 112, side walls 114 extending generally perpendicularly from the joining wall 112 and an opening 116 between the side walls 114. At a point distal to the opening 116, the side walls 114 include apertures that align with each other so that a base pin 130 can extend between the apertures in each side wall 114 and pass through the aperture 23 of the lower deck eye 22 to fix the base 100 in place. A locking handle 142 is located between the side walls 114 and is arranged to lock arm 400 in place as described below. The base pin 130 has a diameter smaller than the inside diameter of the aperture 23 of the deck eye 22. The base pin 130 includes a base pin protrusion 138 that extends along the length and outwardly from the surface of the body of the base pin 130.

In one embodiment, the opening 116 is in the form of a slot.

The locking handle 142 is attached to locking arm 140 which is attached to and arranged to rotate around axle 148 that extends between the side walls 114. The locking arm 140 extends into locking cam 148. The locking cam 148 includes a cap 144 retention member 146 and angled cam protrusion 150, the function of which are described in further detail below.

The base pin protrusion 138 extends away from the base pin 130 into the aperture 23 to position the base pin 130 towards the base 100 with respect to the base pin 130. This prevents excessive movement of the base pin 130 within the aperture 23, and consequently the base 100, when there securing assembly 200 is not under tension to restrain a container. This means that the ability of the securing assembly 200 to pivot about the contact point between the pin 130 and the deck eye 122 is minimised, while preventing the base 100 from separating from the rest of the securing assembly 200. This avoids having to have extra threads that would otherwise need to be unthreaded by a worker. The base pin protrusion also saves weight by avoiding the need of a larger diameter base pin.

As previously noted, the base pin 130 passes through the aperture 23 of the deck eye 22 and through apertures in the side walls 114. On a first end 132b, of the base pin 130 is located an enlarged portion that extends beyond the perimeter of the aperture in the side wall 114 to restrain the base pin 130 from passing through the side wall 114 at one end. The opposite end of the base pin 130 includes a locking end 132a. The locking end 132a is arranged to fix the base pin 130 to the base frame 110 and the deck eye 22. In one embodiment, a locking pin 138, such as a split pin or otherwise is used to lock the base pin 130 in place between the side walls 114 and through the deck eye 22 and thereby lock the base 100 in place.

The base 100, includes ledges 122 extending generally perpendicularly from the end of the sidewalls 114, distal the ends arranged to receive the base pin 130, so that the ledges 122 extend towards each other, forming opening 116 in the form of a slot that extends from the top of ledges 122 to the joining wall 112.

The securing assembly 200 includes a lower arm 400 arranged to engage with the base 100. The arm 400 has a diameter or cross section smaller than the width of the opening 116 so that the arm 400 can pass through the opening 116. The arm 400 includes an enlarged end 402 that has a cross section larger than the width of the opening 116. Ledges 122 include an upper retention extension 120 that extends a short distance towards the end of the sidewalls 114 that receive the base pin 130. The upper retention extension 120 and ledge 122 extending downwardly towards joining wall 112, creating a recess 124. Recess 124 is sized and shaped so that enlarged end 402 fits within the recess 124. Sidewalls 114 are spaced apart so that enlarged end 402 fits between them. In use, to engage the arm 400 with the base 100, enlarged end 402 the arm 400 is aligned above the opening 116 and the enlarged end is moved beyond the ledges 122 so that the arm 400 can be inserted into the opening 116. The arm 400 is lowered into the opening 116 and the enlarged head 402 is pulled into recess 124. The arm in this position will be referred to as the engaged position. In one embodiment, the enlarged head 402 has a profile that restrains rotation of the arm 400 when the enlarged head 402 is in the recess 124.

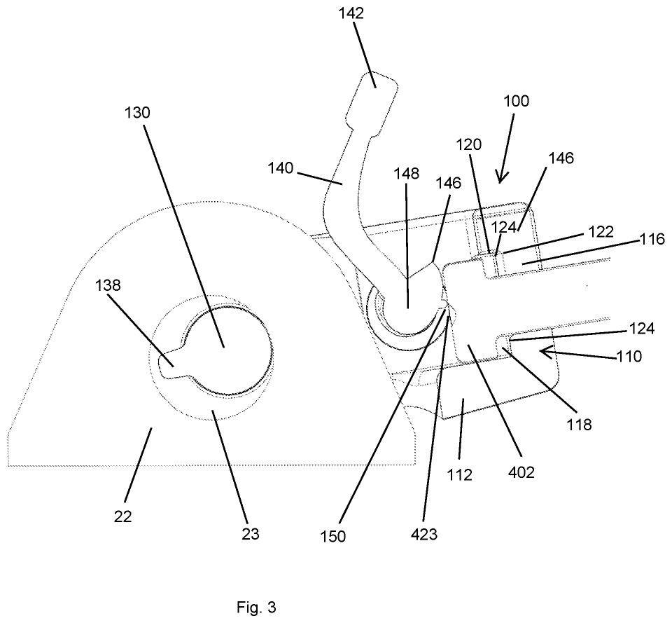

To enable this, the arm 140 is placed in the open position shown in FIGS. 3, 4 and 5. In this position the retention member 146 and angled cam protrusion of cam 148 are raised and provide space for the arm 400 and enlarged head 402 to be lowered into opening 116 and between sidewalls 114. To lock the arm 400 in place when the arm is in the engaged position, the arm 140 and handle 142 are lowered so that retention member 146 is below protrusion 423 on enlarged head 402. The protrusion 423 acts to restrain the retention member 146 from moving upwards unlocking the arm 400.

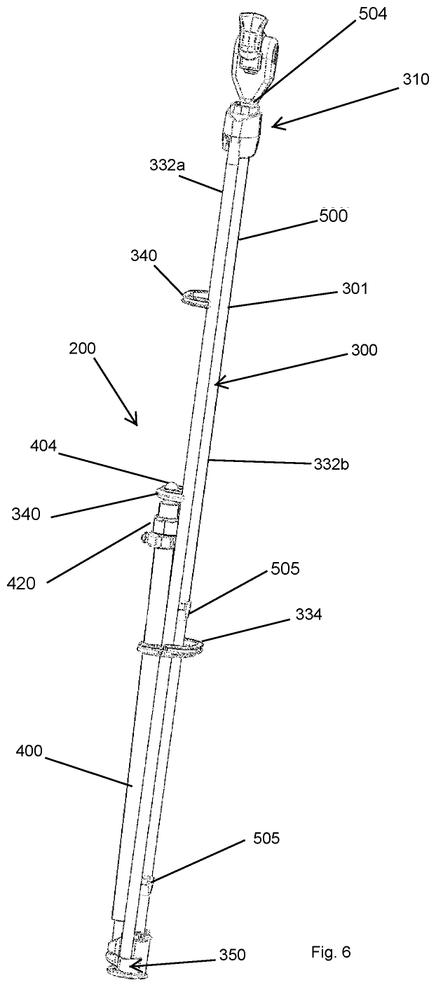

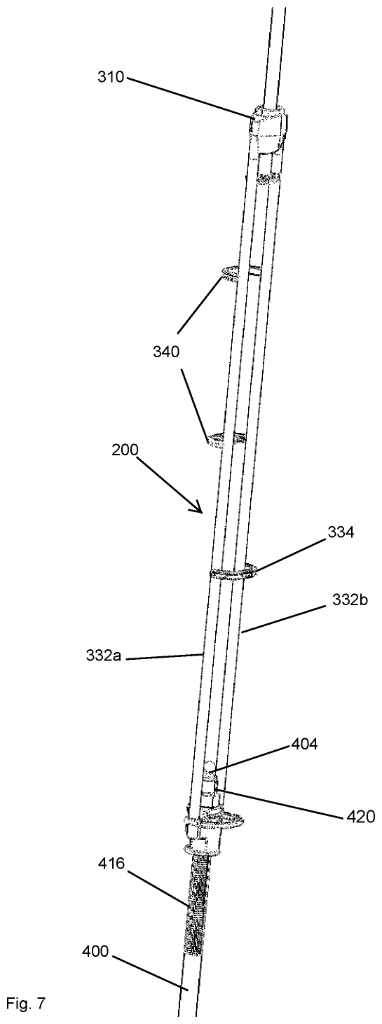

With reference to FIGS. 6 and 7 the frame 300 of the securing assembly 200 is shown the frame 300 includes central frame 301 comprising a first rod 332a and a second rod 332b, a base frame bracket 350, a top bracket 310, frame brackets 334 and stow brackets 340. Arm 400 engages and slides up and down along the frame 300. Arm 400 includes top ball 404 at its upper end, separated from the body of the arm 400 by a reduced neck region. Frame brackets 334 create the spacing and relative position of the first and second rods 332a, 332b so that a uniform spacing between the first and second rods 332a and 332b is maintained. As will be described below, stow brackets 340 are shaped and arranged to receive the top ball 404 and nut slider assembly 420 to restrain the arm 400 from sliding in the direction of the base frame bracket 350. The arm 400 includes thread 416 in its upper region that is arranged to be threaded through a mating thread on the locking nut assembly 420 as discussed below. In one embodiment the threaded portion 416 is located on an inner extendable portion that is surrounded by a sheath. The outer surface of the arm 400 includes a engagement portion that is arranged to restrain rotation of the arm in use as will be described further below. In one embodiment the engagement portion is a slot.

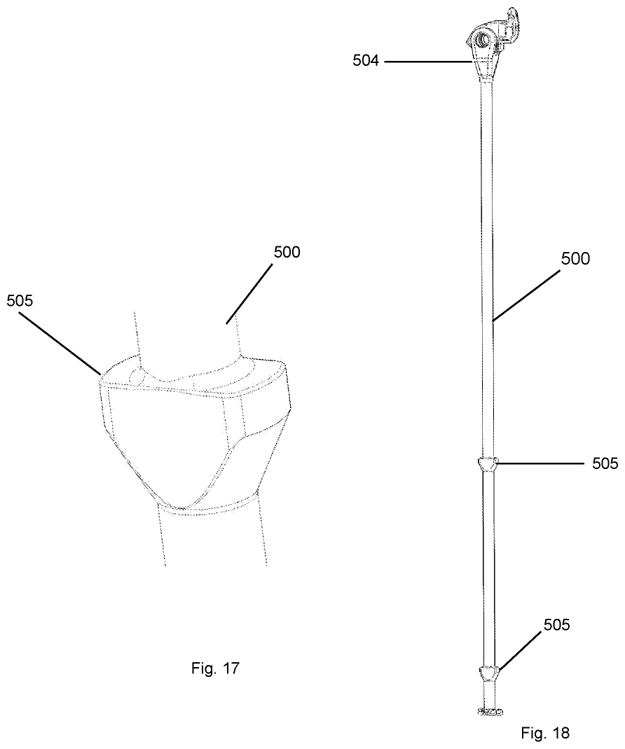

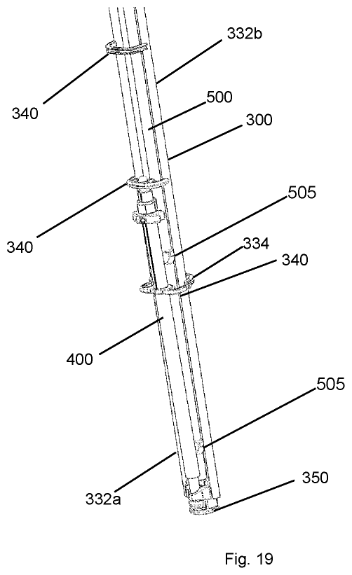

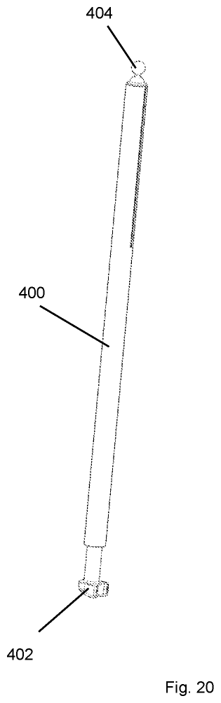

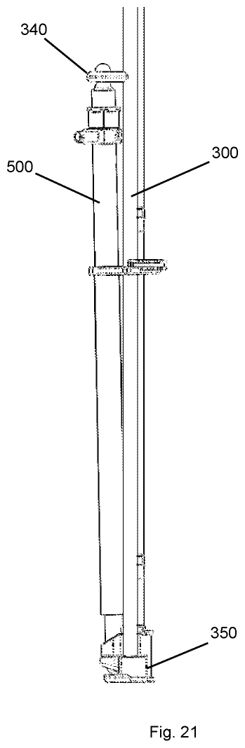

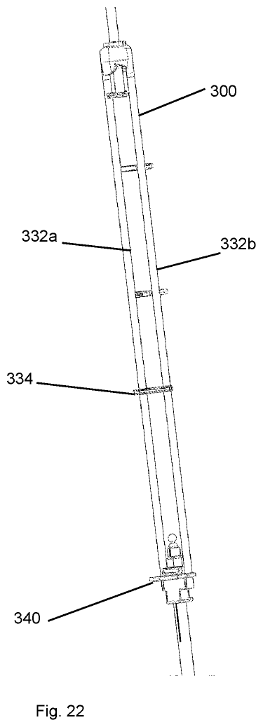

FIGS. 15 to 18 illustrate upper arm 500 that is arranged to attach to a shipping container and to the top bracket 310 of the frame 300. Top rod head 504 is arranged to engage upper corner casting and lower pill holes on a container to restrain the securing assembly 200. The body of upper arm includes asymmetric stops 505 that include angled sides that extend from the body of the upper arm 500 and provide an enlarged upper surface to provide a generally truncated triangular shape. The asymmetric stops 505 are arranged to engage with the upper bracket 310 as discussed below.

The base end of upper arm 500 includes a base slider 510 that includes curved ends 512 located on the sides of the upper arm and arranged to abut first and second rods 332a and 332b to maintain the upper arm 500 in position when the upper arm moves with respect to the frame 300. The base slider 510 engages the upper arm 500 through inserting a reduced size end with projection 507 of the upper arm 500 into well 508 which is profiled to only allow rotation of the upper arm 500 by no more than 90 degrees. Base lip 600 is used as a handle portion to allow lifting of the upper arm 500. The side of the upper arm 500 opposite the base lip 600 is flared with an inset central section that flares out to curved ends 512. This region allows a portion of the arm 400 to be adjacent the base slide 510 when the securing assembly is stowed.

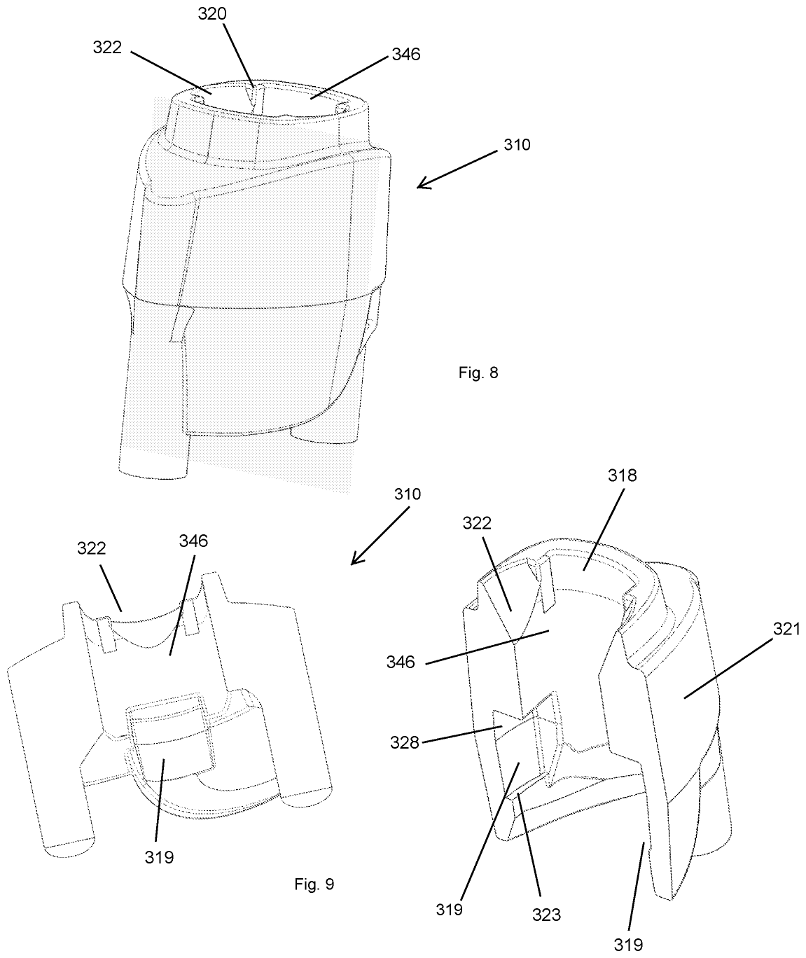

FIGS. 8 and 9 illustrate the top bracket 310 attached to the frame 300. The top bracket 310 includes a well 346 consisting of a plurality of interrelated cavities arranged to restrain the movement of the upper arm 500 through the bracket, whilst still allowing the upper arm to pass through with specific manipulation.

The upper end of top bracket 310 includes first sloped surfaces 322 on opposite sides of the top bracket 310. The first sloped surfaces 322 are arranged to receive the asymmetric stops 505, but not allow them to pass through the well 346. To allow the asymmetric stops 505 to pass the first sloped surfaces 322, the upper arm 500 is lifted sufficiently so that the asymmetric stops 505 is able to pass over wall 320 and align over first cavity 318. The asymmetric stops 505 is able to be lowered into first cavity 318 and the first cavity surface 321 guides the asymmetric stops 505 into second cavity 319. Second cavity 319 includes an upper surface 328 that restrains the asymmetric stops 505 restrains the upper rod's movement and a base ledge 323 that restrains the asymmetric stops 505 from downwards movement. To move the asymmetric stops 505 beyond the second cavity 319, the asymmetric stops 505 is lifted and rotated by 90 degrees. In this rotated position, the asymmetric stops 505 can pass through and out of the top bracket 310. into the frame 300. The asymmetric stops 505 enable an operator to easily lengthen the securing assembly 200 to approximately the right height by having the securing assembly 200 lean in one direction and then, by leaning it tin an opposite direction, keep raising upper arm 500 until it hits the asymmetric stop 505, at which point the operator can be certain that the securing assembly 200 is at precisely (within a small tolerance) the right height to be twisted and locked in place, ready to be attached to the container.

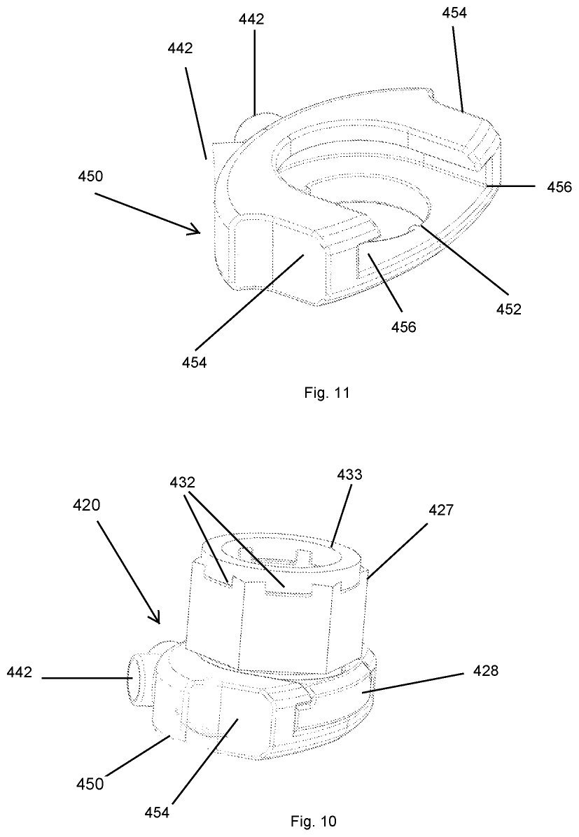

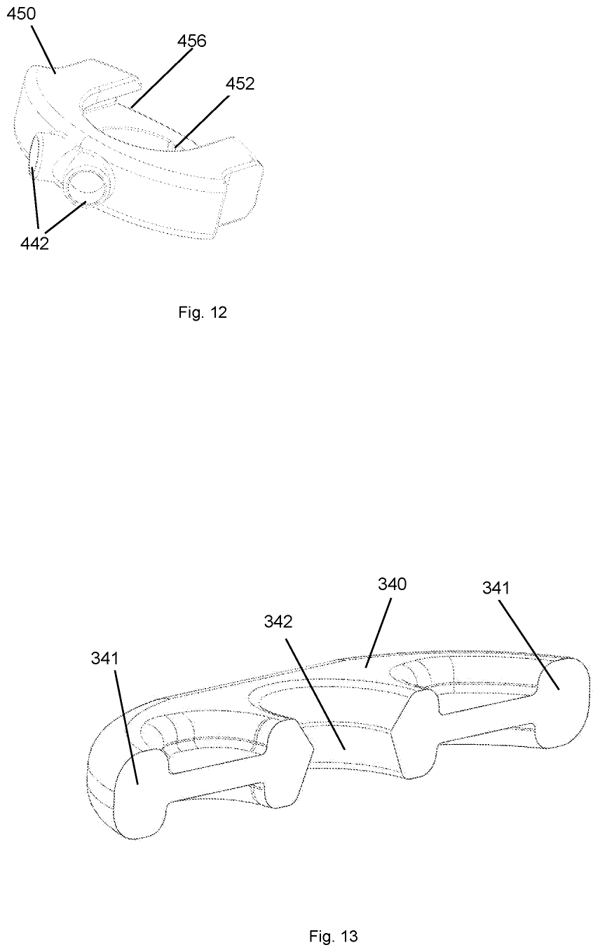

Referring to FIGS. 10, 11 and 12, a lock nut assembly 420 for engaging the top ball 404 region of the arm 400. The lock nut assembly 420 includes a nut 427 arranged to engage a slider 450. In one embodiment, a flange (not shown) at the base of the nut 427 is arranged to engage recess 456 in the slider 450. The nut 427 is rotatable with respect to the slider 450 to allow the nut to thread onto thread 416 of arm 400 and stops the nut 427 from moving out of the slider in a direction along the length of the arm 400 out of the slider 450. In one embodiment the top of the nut 427 is castellated. The recessed portions 432 of the castellations of nut 427 are arranged to engage with corresponding protruding portions of a castellated ring 433. In one embodiment, the castellated ring 433 is splined on its radially outwards surface.

A plastic insert 428 is sized and shaped to insert into the recess 456 and prevent the ingress of debris into the recess 456. In one embodiment, the plastic insert 428 includes a RFID chip.

The slider 450 includes bosses 452 extending inwardly into an aperture arranged to receive arm 400. The bosses 452 are arranged to extend into the above noted engagement portion of the arm 400 and restrain it from rotation.

When not in the stowed position (as discussed further below) curved surfaces 454 of the slider created a reduced width portion of the slider 450. This reduced width portion of the slider is arranged to fit between the first and second rods 332a, 332b whilst the enlarged portion of the slider cannot fit between the first and second rods 332a, 332b. This allows the slider to up and down along the first and second rods 332a, 332b.

The slider 450 includes apertures 442 distal the opening of the recess 456 arranged to receive handles for manipulating the securing assembly.

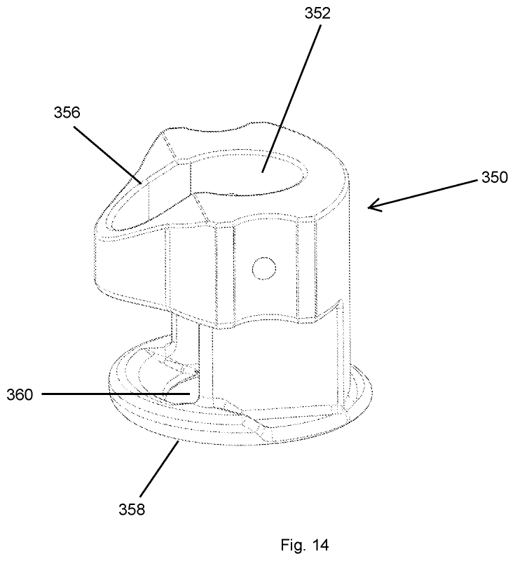

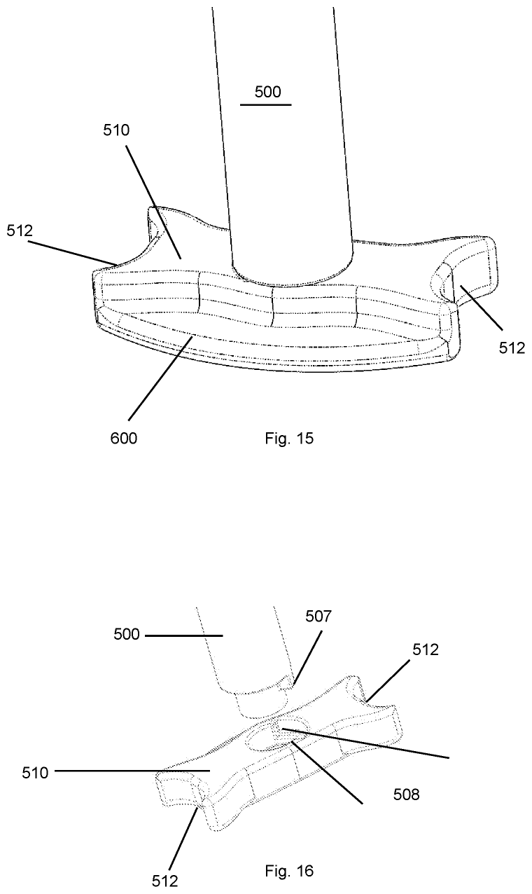

With reference to FIG. 14, the base bracket 350 of the frame 300 is described. The base bracket 350 includes aperture 352 through which arm 400 extends, base lip 358 and base bracket recess 360. The aperture 352 is of a non-circular profile to allow angular movement of the arm 400 and still enable upwards and downwards movement of the arm 400 through the base bracket 450 without the arm 400 jamming. The aperture 352 is sized with a smaller diameter forwards region 356 to allow the enlarged head 402 to pass through it to a certain point along the length of the aperture where the size of the aperture changes and the head can go no further in the forwards region 356.

With reference to FIG. 13, the stow bracket 340 will be described further. The ends 341 are fixed to the first and second rods 332a, 332b via welding or other fixing means. The central region of the stow brackets includes an aperture to allow the reduced neck region of the rod to be inserted to prepare the lash for stowage and a curved recess 342 arranged to receive the reduced neck region between the top ball 404 and the conical shape included at the top of the body of the arm 400. The curved recess 342 has opposing upper and lower cone shapes that, when arm 400 is in the lowered position the top ball 404 nests on the upper surface of the curved recess 342 and when arm 400 is in the raised position the conical shape, the top ball 404 nests on the lower surface of the curved recess 342. When the arm 400 is lowered, the nesting prevents the neck moving through the aperture and thus the securing assembly 200 can be safely moved without the length of the arm 400 changing further. Similarly, when the operator has lifted the arm 400 to place it into position, the nesting prevents the rod falling out through the aperture if the rod is used to lift the entire assembly.

The shape of the lower curved recess is such that it allows the easy entry of the arm 400 into the curved recess and prevents the arm 400 coming out when the arm 400 is ready for lifting.

When the arm 400 is in use and not in the stowed position, the enlarged head 402 is passed through the aperture 352 to be located beyond the bottom bracket

Although the invention has been described with reference to a preferred embodiment, it will be appreciated by those skilled in the art that the invention may be embodied in other forms.

The advantageous embodiments and/or further developments of the above disclosure—except for example in cases of clear dependencies or inconsistent alternatives—can be applied individually or also in arbitrary combinations with one another.

Washer underneath the slider stops the rod in the right position and stops the rod from coming too far forward and therefore from missing the storage bracket.

When the securing assembly 200 is engaged with deck eye 22 and an item to be retrained and the securing assembly 200 is tensioned the securing assembly components as described above do not move.

1-65. (canceled)

66. A base for a securing assembly having a lower end that secures objects to a structure, the base including:
a base frame having a joining wall and at least two sidewalls extending from the joining wall to an opening for receiving the lower end in a cavity;
a base pin extending between the sidewalls for attaching the base to the structure;
an arm movable between an open position, wherein the arm is positioned such that the lower end is movable through the opening, and a securing position, wherein the arm inhibits movement of the lower end from the cavity.

67. The base of claim 66, wherein the arm includes a retention member that engages a retention feature of the base frame to inhibit movement of the arm relative to the base frame except for movement between the open position, the securing position, and an assembly position,
wherein, in the assembly position, the arm is removable from the base frame, and
wherein the arm is located at a distance from the base pin such that, when the base is secured to a deck eye of the structure, the deck eye prevents movement of the arm to the assembly position.

68. The base of claim 66, wherein the arm includes an axle about which the arm pivots between the open position and the securing position, and wherein the axle includes a cam positioned such that, when the arm is in the open position and the lower end is moved through the opening into the cavity, the lower end engages the cam and urges the arm toward the securing position.

69. The base of claim 66, wherein the arm includes an axle about which the arm pivots between the open position and the securing position, and wherein the axle includes a sloped boss positioned such that, when the lower end is received by the cavity and the arm is in the securing position, the sloped boss urges the lower end toward the bottom wall.

70. The base of claim 66, wherein the base pin has, at a first end, an end cap, and, at a second end, a base pin locking pin inserted perpendicularly through the base pin to prevent removal of the base pin from the base frame.

71. The base of claim 66, wherein the base includes a mother frame that is attachable to the structure, wherein the frame is locatable in the super frame in a plurality of positions extending along a mother frame axis using a mother frame pin.

72. A securing assembly for securing an object to a structure, the assembly including:
a frame extending along a frame axis;
a first arm movably connected to the frame, the first arm having:
a lower end adapted to connect to the structure; and
an upper end connected to the frame,
a second arm having:
a lower end connected to the frame; and
an upper end extending away from the frame, and
an engaging member attached to the upper end of the second arm, the engaging member being adapted to engage an attachment point of the object,
wherein the first arm is movable between a securing position, wherein the lower end is connectable to the structure, and a stowed position, wherein the first arm is at least partly received by the frame such that at least a portion of a projection of the first arm along the frame axis overlaps a portion of a projection of the second arm along the frame axis.

73. The securing assembly of claim 72, wherein, in the stowed position, the first arm extends at an angle to the frame such that the second arm is movable along the frame axis.

74. The securing assembly of claim 72, wherein the frame includes a top bracket and the second arm includes a slider at the lower end thereof,
wherein the top bracket engages with the slider to prevent removal of the second arm from the frame.

75. The securing assembly of claim 74, wherein the second arm includes one or more asymmetric stops, and wherein the top bracket has a top recess, the top recess having:
a first contour portion that allows movement of the second arm relative to the top bracket; and
a second contour portion offset from the first contour portion that inhibits movement of the second arm relative to the bracket when the asymmetric stop engages the second contour portion.

76. The securing assembly of claim 74, wherein the second arm includes one or more asymmetric stops, and wherein the top bracket has an internal cavity with an upper surface adapted to receive the asymmetric stop in a securing position to resist tension applied to the second arm,
wherein the cavity has a third contour portion that allows movement of the second arm relative to the top bracket and a fourth contour portion that inhibits movement of the second arm relative to the top bracket due to tension applied to the second arm when the asymmetric stop is in the securing position.

77. The securing assembly of claim 76, wherein the top bracket has a top recess, the top recess having:
a first contour portion that allows movement of the second arm relative to the top bracket; and
a second contour portion offset from the first contour portion that inhibits movement of the second arm relative to the bracket,
wherein the fourth contour portion is aligned with the second contour portion such that when the second arm is in the securing position and tension is removed from the second arm, movement of the second arm is inhibited when the asymmetric stop engages the second contour portion.

78. The securing assembly of claim 72, wherein the securing assembly further includes a lock nut assembly attached to the upper end of the first arm, and the frame includes a bottom bracket, the bottom bracket having a channel to allow movement of the first arm through the channel, wherein the lock nut assembly includes:
a body with a lower surface to bear against an upper surface of bottom bracket; and
a threaded part matching a thread on the first arm,
wherein rotation of the threaded part relative to the first arm with the threaded part being engaged with the thread on the first arm causes upward movement of first arm relative to the lock nut assembly and the bottom bracket, thereby tensioning the assembly.

79. The securing assembly of claim 78, wherein the lock nut assembly includes a removable securing member that has an internal projection that engages a recess in the first arm to inhibit rotation between the first arm and the securing member, wherein the securing member is further engaged with the threaded part such that, when the securing member is engaged with the threaded part, rotation of the threaded part is inhibited by the engagement of the securing member with the recess.

80. The securing assembly of claim 72, wherein the securing assembly has at least two side rods that are separated by one or more frame brackets and further includes a slider movably attached to the first arm, the slider having a projection for engaging a recess in the first arm to inhibit rotation of the first arm relative to the slider,
wherein the slider has arms extending outwardly from the slider and configured to, when the first arm is in the stowed position, abut one of the side rods of the frame to resist a torque applied to the first arm.

81. A lifting aid for lifting the securing assembly of claim 72 for securing an object to a structure, the lifting aid including:
a pivot point that is attachable to the structure;
a counterbalancing carrier connected to one side of the pivot point; and
a lifting point at a second side of the pivot point, the lifting point being configured to lift the securing assembly from a rest position to an installation position, in which the securing installation is attachable to the object to be secured.

82. The lifting aid of claim 81, wherein the counterbalancing carrier includes one or more of:
a counterweight;
a resistive spring;
hydraulic lifting means; and
electric lifting means.

83. The securing assembly of claim 74, wherein the frame includes at least two side rods that are separated by one or more frame brackets, and the slider has a width that is larger than a separation of the side rods,
wherein the slider has a recess for each side rod such that movement of the slider is guided by the side rods.

84. The securing assembly of claim 76, wherein the cavity includes a second shoulder portion aligned with the fourth contour portion to inhibit movement of the second arm relative to the top bracket when tension is removed from the second arm and the asymmetric stop engages the fourth contour portion.

85. The securing assembly of claim 84, wherein the fourth contour portion includes a first shoulder portion that engages a side surface of the lower end of the second arm to resist torsion applied to the second arm,
wherein the second shoulder portion is located below the first shoulder portion to support the second arm in a position that allows rotation of the second arm from a position that engages the fourth contour portion to a position that allows movement of the second arm relative to the top bracket.
